(19) United States
(12) Patent Application Publication
(10) Pub. No.: US 2005/0138591 A1
(43) Pub. Date: Jun. 23, 2005

(54) Layout device

(75) Inventors: Naoki Shirai, Kasugai (JP); Junji Tomida, Kasugai (JP); Jun Makihara, Kasugai (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/013,372

(22) Filed: Dec. 17, 2004

(30) Foreign Application Priority Data
Dec. 19, 2003 (JP) 2003-421844
Oct. 28, 2004 (JP) 2004-314414

(51) Int. Cl. G06F 9/455; G06F 17/50

(52) U.S. Cl. 716/11

(57) ABSTRACT

A layout device that reduces work. The layout device includes a storage unit for storing position information of patterns generated through layout designing. A display unit displays the patterns in accordance with a layout corresponding to the position information. An input unit enables a user to designate a pattern from one of the patterns displayed on the display unit as a marked pattern and enables the user to designate a hierarchical level of the hierarchical structure to which the marked pattern belongs as a reference level. A processing unit, connected to the storage unit, the display unit, and the input unit, obtains coordinates of the marked pattern using the position information of the patterns in the reference level that is stored in the storage unit and dumps the obtained coordinates to the display unit.

### CROSS-REFERENCE TO RELATED APPLICATIONS

This application is based upon and claims the benefit of priority from the prior Japanese Patent Application No. 2003-421844, filed on Dec. 19, 2003, and Japanese Patent Application No. 2004-314414, filed on Oct. 28, 2004, the entire contents of which are incorporated herein by reference.

### BACKGROUND OF THE INVENTION

The present invention relates to a layout device, a layout method, and a layout program for designing a layout for a semiconductor integrated circuit using pattern data having a hierarchical structure.

In recent years, the scale and integration density of semiconductor integrated circuits (e.g., LSI) have become higher. This has increased the amount of data used for designing. For this reason, processes for layout designing and layout checking have a tendency to consume more time when designing a semiconductor integrated circuit. Accordingly, there has been a demand for a technique that shortens the time required for the layout designing and checking.

The layout of a semiconductor integrated circuit (LSI) is designed using pattern data having a hierarchical structure as shown in FIG. 1. When designing the layout for an LSI and verifying the layout, in addition to coordinates representing a position (which will hereinafter be referred to as “position coordinates”) for pattern data on a two-dimensional plane, the hierarchical structure must also be taken into consideration. However, in the prior art, there is no means for assisting efficient understanding of the relationship between the position coordinates and the hierarchical structure of the pattern data. Thus, the designing and checking of a layout impose a heavy burden on a designer. For example, referring to FIG. 1, when assuming that a designer marks out a pattern at a lower hierarchical level ALUCEL, the designer needs to know position coordinates for the pattern in accordance with the coordinate system used for the hierarchical level ALU. In the prior art, the recognition of the position coordinates in accordance with the coordinate system of the hierarchical level ALU would require much labor on the part of the designer.

More specifically, a conventional layout display tool displays coordinates for a pattern in two ways. The first way is by displaying coordinates for a pattern in accordance with the coordinate system of the uppermost hierarchical level (hierarchical level 1A in FIG. 1). The other way is by displaying coordinates for the pattern in accordance with the coordinate system of the hierarchical level to which the pattern belongs (hierarchical level ALUCEL in FIG. 1). However, the conventional layout display tool cannot display coordinates in accordance with the coordinate system of other hierarchical levels. Accordingly, in order for the designer to correct an error found when conducting a design rule check (DRC) on an entire chip, the designer must perform complicated procedures, which will now be described.

For example, referring to FIG. 2, the DRC may be carried out on a semiconductor integrated circuit 1. A plurality of functional blocks 2-7, such as a cell or a function macro, and a plurality of input/output cells 8, which are arranged around the functional blocks 2-7, are arranged in the semiconductor integrated circuit 1 as shown in FIG. 2. After the DRC is finished, the entire chip for the semiconductor integrated circuit 1 is displayed (full view mode display) as the DRC results to show and report the site of an error (position indicated by an arrow in FIG. 2). In the example shown in FIG. 2, an error is detected in the wiring pattern for the functional block 7 in the semiconductor integrated circuit 1.

The coordinates for a pattern detected as having an error (erroneous pattern Er) during the DRC is reported in accordance with the coordinate system of the uppermost hierarchical level of the chip. Subsequently, the designer zooms in on (magnifies) the erroneous site (zoom mode display) as shown in FIG. 3. Then, the designer identifies the name of the hierarchical level to which the erroneous pattern Er belongs. The designer designates the hierarchical level to which the erroneous pattern Er belongs as the hierarchical level which is to be next displayed and displays that hierarchical level (more specifically, displays a cell structure containing the erroneous pattern Er), as shown in FIG. 4. Next, the designer zooms in on the hierarchical level containing the erroneous pattern Er to re-display the erroneous pattern Er as shown in FIG. 5. After that, the designer finds the erroneous pattern Er and identifies the coordinates for the erroneous pattern Er in accordance with the coordinate system of the hierarchical level to which the erroneous pattern Er belongs. Then, the designer changes the configuration of the erroneous pattern Er to eliminate the error so that the quality of design data is kept high.

The layout display tool of the prior art provides a process for obtaining route hierarchical level names for a single pattern. However, the hierarchical level names and position information for a plurality of patterns cannot be simultaneously obtained. For example, an error (e.g., insufficient interval) resulting from a plurality of patterns may be detected through DRC. The error is not produced by the coordinates (position and shape) of an individual pattern. Thus, the position information of a hierarchical tree route including the hierarchical levels to which the erroneous patterns belong must be checked entirely. As described below, the procedures for doing so is complicated.

For example, referring to FIG. 6, a functional block includes three hierarchical levels A, B, and C. Hierarchical level C includes two patterns C1 and C2 (as indicated in parentheses). A layout device (computer) that performs DRC recognizes patterns C1 and C2, which are included in hierarchical level C, as patterns H1 and H2. When an insufficient interval error is detected between the patterns H1 and H2 through DRC, the designer acquires all the position information of a hierarchical tree route to which the hierarchical level including patterns H1 and H2 belongs.

In the same manner as when there is an error due to a single pattern, as shown in FIG. 6, the designer zooms in on (magnifies) the display of the erroneous site. The designer then checks the names of the hierarchical levels to which the erroneous patterns belong to retrieve information of the route hierarchical level names as shown in FIG. 7. The designer performs such checking on the related erroneous patterns. The designer visually checks whether the route hierarchical name and position information (coordinates, rotation, mirror image) of the hierarchical level to which a certain erroneous pattern belongs matches the route hierarchical name and position information of the hierarchical level to which another erroneous pattern belongs. Matching information is classified as “same hierarchical tree route” and non-matching information is classified as “different hierarchical tree route.” The designer locates the hierarchical level to which an erroneous pattern is allocated from the route hierarchical level name. Then, as shown in FIGS. 8A and 8B, the designer designates the allocated hierarchical level as the uppermost hierarchical level and re-displays it on a display. In this state, the designer searches for the hierarchical levels in which the erroneous patterns are located to acquire position information. For example, referring to FIG. 8A, the designer acquires position information (coordinates, rotation, mirror image) of hierarchical level B that is included in hierarchical level A, as shown in FIG. 8A, and then acquires position information (coordinates, rotation, mirror image) of hierarchical level C that is included in hierarchical level B, as shown in FIG. 8B.

When a plurality of erroneous patterns belong to the same hierarchical tree route, the designer sets the hierarchical level of the erroneous pattern as the uppermost hierarchical level and re-displays the hierarchical level of the erroneous pattern on the display. After locating an erroneous pattern, the designer changes the coordinates (shape and positional relationship) of the erroneous pattern. Errors are resolved in this manner to maintain the quality of design data. However, there may be a case in which a plurality of erroneous patterns belong to different hierarchical tree routes. In such a case, even if the related erroneous patterns all belong to the same hierarchical level, the designer must check not only the accuracy of the coordinates (shape and positional relationship) of the erroneous patterns but also the accuracy of all the position information (coordinates, rotation, mirror image) of the hierarchical tree route for the hierarchical levels to which the erroneous patterns belong. When doing so, the designer acquires position information by referring again to the information acquired when checking matching position information or by searching for the route hierarchical level as described above. The designer performs such checking on all of the hierarchical levels including the related erroneous patterns to search for locations that are to be corrected.

Subsequently, the designer changes the coordinates (shape and positional relationship) and the position information of the erroneous patterns. Errors are resolved in this manner to maintain the quality of design data.

A layout is not designed in units of hierarchical levels but in units of cells or macros (functional block units), which is a broader concept than hierarchical levels. A cell includes a plurality of hierarchical levels, and a macro includes a plurality of cells. For example, the design for a layout may be performed by a number of designers who design functional blocks, such as macros and coals. In such a case, each designer needs to know information about the macro or the cell to which an erroneous pattern belongs and the position of the erroneous pattern in accordance with the coordinate system of that macro or cell containing the erroneous pattern. Accordingly, the designer needs to know the coordinates for the erroneous pattern in accordance with the coordinate system employed by the macro or the cell containing the erroneous pattern and not in accordance with coordinate system employed by a level to which the erroneous pattern belongs. In other words, the designer must use coordinate system for a middle hierarchical level of the chip to locate an erroneous pattern. Thus, the designer cannot use the coordinate system of the hierarchical level to which the erroneous pattern belongs and must use the coordinate system of an upper hierarchical level such as a cell or a macro to specify an erroneous pattern. In order to obtain coordinates in the coordinate system of the middle hierarchical level, the designer has to perform an additional calculation.

In order to specify the name of a hierarchical level (hierarchical level name) to which the erroneous pattern belongs and the coordinates of the erroneous pattern in that hierarchical level, the designer needs to acknowledge the coordinates representing the position of the erroneous pattern while changing the hierarchical level displayed by the display tool. Thus, much labor is required to specify the level name and the coordinates of the erroneous pattern. Also, the designer changes the display mode from the full view mode (refer to FIG. 2) to the zoom mode (refer to FIG. 3) and then acknowledges the erroneous pattern. Thereafter, the designer is required to visually confirm that the erroneous pattern displayed in the zoom mode is the same as the erroneous pattern re-displayed in the hierarchical level to which the erroneous pattern belongs (refer to FIG. 5). The coordinate system employed in the zoom mode display (refer to FIG. 3) and the coordinate system employed when re-displaying the erroneous pattern (refer to FIG. 5) may differ from each other. In such a case, the erroneous pattern is re-displayed reflecting information related to the position of the erroneous pattern, such as rotation, mirror, and offset (which will hereinafter be referred to as “position information”). For example, the erroneous pattern Er shown in FIG. 5 is shown by rotating the erroneous pattern Er shown in FIG. 3 by 90°. Accordingly, it is difficult for the designer to quickly acknowledge the re-displayed erroneous pattern Er. This is likely to increase the time required for acknowledgement and may also increase the possibility of human error.

To check whether a plurality of erroneous patterns belong to the same hierarchical tree route, based on the route hierarchical level name (refer to FIG. 7), the designer designates each route hierarchical level as the uppermost hierarchical level and displays the route hierarchical level on the display (refer to FIGS. 8A and 8B). Then, the designer searches for position information of the associated hierarchical levels (e.g., hierarchical level B for hierarchical level A, and hierarchical level B of hierarchical level C). Afterwards, the designer traces the pattern route while visually checking the route hierarchical level name and position information. Such a task is burdensome. The layout data may have a large number of similar hierarchical level names and the hierarchical structure may be deep. In this case, a large amount position information must be checked. As a result, accurate checking is difficult.

When a plurality of error patterns belong to different hierarchical tree routes, the accuracy of the position information (coordinates, rotation, mirror image) for route hierarchical levels must be visually checked. For example, hierarchical level C, to which the erroneous patterns C1 and C2 of FIG. 6 belong, are rotated in hierarchical levels A and B, which are routed with hierarchical level C. Thus, accurate identification of the associated hierarchical level relying on the position coordinate is very difficult and burdensome. This increases the checking time and may cause human errors.

The hierarchical tree route is long when the hierarchical structure of the layout data is deep. In this case, the designer must eliminate invalid tree routes and focus on valid tree routes. However, there is no means to know which hierarchical tree routes are valid. Thus, the designer must conduct a search on every route hierarchical level to determine valid routes. This further increases the checking time and human errors.

The present invention provides a layout device and a layout method that reduces workload associated with layout designing and layout checking.

One aspect of the present invention is a layout device for designing a layout by a user for a plurality of patterns using pattern data having a hierarchical structure. The device includes a storage unit for storing position information of the patterns generated through the designing of the layout. A display unit displays the patterns in accordance with a layout corresponding to the position information. An input unit enables the user to designate a pattern from one of the patterns displayed on the display unit as a marked pattern and enables the user to designate a hierarchical level for the hierarchical structure to which the marked pattern belongs as a reference level. A processing unit, which is connected to the storage unit, the display unit, and the input unit, obtains coordinates of the marked pattern using the position information of the patterns in the reference level that is stored in the storage unit and dumps the obtained coordinates to the display unit.

Another aspect of the present invention is a layout device for designing a layout by a user for a plurality of patterns using pattern data having a hierarchical structure. The device includes a storage unit for storing position information of the patterns generated through the designing of the layout. A display unit displays the patterns in accordance with a layout corresponding to the position information. An input unit enables the user to designate a pattern from one of the patterns displayed on the display unit as a marked pattern and enables the user to designate a hierarchical level of the hierarchical structure to which the marked pattern belongs as a reference level. A processing unit, which is connected to the storage unit, the display unit, and the input unit, obtains coordinates of the marked pattern using the position information of the patterns in the reference level that is stored in the storage unit and dumps the obtained coordinates to the display unit. The processing unit displays a layout origin, a quantity of columns and rows, an interval between patterns in columns and rows, and column and row numbers for each hierarchical level in the hierarchical structure of the marked pattern as detailed information of the marked pattern on the display unit. The processing unit displays a sub-window showing the coordinates of the marked pattern in accordance with a coordinate system for the reference level on the display unit.

A further aspect of the present invention is a layout method for aiding a user in processing a layout to perform layout designing of a plurality of patterns using pattern data having a hierarchical structure. The method includes reading position information of the patterns generated through the layout designing, displaying the patterns in accordance with a layout corresponding to the position information, designating a pattern from the patterns as a marked pattern in accordance with a first input from the user, designating a hierarchical level of the hierarchical structure of the marked pattern as a reference level in accordance with a second input from the user, obtaining coordinates of the marked pattern using the position information of the patterns in the reference level, and dumping the obtained coordinates to the display unit.

A further aspect of the present invention is a layout device for designing a layout for a plurality of patterns using pattern data having a hierarchical structure. The hierarchical structure includes hierarchical levels, each including a wire. The device includes a storage unit for storing position information of the patterns generated through the designing of the layout. A check unit checks the layout of the plurality of patterns by searching for the wire included in a predetermined one of the hierarchical levels based on the position information and generating connection information from information of the wire. A setting unit sets a marked pattern from the plurality of patterns based on the checking result of the layout. A hierarchical structure storage unit stores the hierarchical structure to which the marked pattern belongs. A hierarchical information extraction unit generates information of the hierarchical level including the wire that is to be searched by the check unit based on the position information of the hierarchical structure stored in the hierarchical structure storage unit. The test unit retests the layout based on the information of the hierarchical level including the wire that is to be searched.

A further aspect of the present invention is a layout method for performing layout designing of a plurality of patterns using pattern data having a hierarchical structure. The hierarchical structure includes hierarchical levels, each including a wire. The method includes storing position information of the patterns generated through the layout designing, searching for a wire included in a predetermined hierarchical level based on the position information, testing the layout by generating connection information from information of the wire, setting a pattern of the plurality of patterns as a marked pattern based on the result of the layout check, storing the hierarchical structure to which the marked pattern belongs, generating information of the hierarchical level including the wire that is to be searched based on the position information of the stored hierarchical structure, and retesting the layout based on the information of the hierarchical level including the wire that is to be searched.

A further aspect of the present invention is a computer program product for use by a user, comprising a storage medium encoding computer-readable instruction steps for designing a layout of a plurality of patterns using pattern data having a hierarchical structure. The instruction steps when executed by a computer performs steps include reading position information of the patterns generated through the designing of the layout, displaying the patterns in accordance with a layout corresponding to the position information, designating a pattern from the patterns as a marked pattern in accordance with an input from the user, designating a hierarchical level of the hierarchical structure of the marked pattern as a reference level in accordance with another input from the user, obtaining coordinates of the marked pattern using the position information of the patterns in the reference level, and dumping the obtained coordinates to the display unit.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a diagram schematically showing the structure of pattern data;

FIG. 2 is a diagram showing the layout of functional blocks in a semiconductor integrated circuit;

FIG. 3 is a diagram showing an erroneous site in the semiconductor integrated circuit of FIG. 2 in a magnified state;

FIG. 4 is a diagram showing a cell structure containing an erroneous pattern;

FIG. 5 is a diagram showing the erroneous pattern of FIG. 4 in a magnified state;

FIG. 6 is a diagram showing a cell structure;

FIG. 7 is a diagram showing a display of route hierarchical level names in the prior art;

FIGS. 8A and 8B are diagrams showing the acquisition of position information for each route hierarchical level;

FIG. 9 is a block diagram schematically showing the structure of a layout device according to a first embodiment of the present invention;

FIG. 10 is a flowchart showing a layout display process performed by the layout device of FIG. 9;

FIG. 11 is a chart showing the results of a dump in accordance with a coordinate system of a designated hierarchical level;

FIG. 12 is a diagram showing an example of an Aref layout;

FIG. 13 is a flowchart showing a layout display process performed by the layout device of FIG. 9 that has an additional function;

FIG. 14 is a flowchart showing a hierarchical tree display process according to a second embodiment of the present invention;

FIG. 15 is a flowchart showing the processing following the hierarchical tree display process of FIG. 14;

FIG. 16 is a diagram showing a hierarchical tree display;

FIG. 17 is a diagram showing a cell structure;

FIG. 18 is a diagram showing a route hierarchical level name display in the prior art;

FIG. 19 is a diagram showing a hierarchical tree display;

FIG. 20 is a diagram showing a cell structure;

FIG. 21 is a diagram showing a hierarchical tree display;

FIG. 22 is a diagram showing a hierarchical tree display;

FIG. 23 is a schematic flowchart of a design process according to a third embodiment of the present invention;

FIG. 24 is a diagram showing a cell structure;

FIG. 25 is a diagram showing a cell structure;

FIG. 26 is a diagram showing a hierarchical tree display;

FIG. 27 is a diagram showing a cell structure;

FIG. 28 is a diagram showing a hierarchical tree display; and

FIG. 29 is a diagram illustrating exposure data.

### DETAILED DESCRIPTION OF THE PREFERRED EMBODIMENTS

In the drawings, like numerals are used for like elements throughout.

### First Embodiment

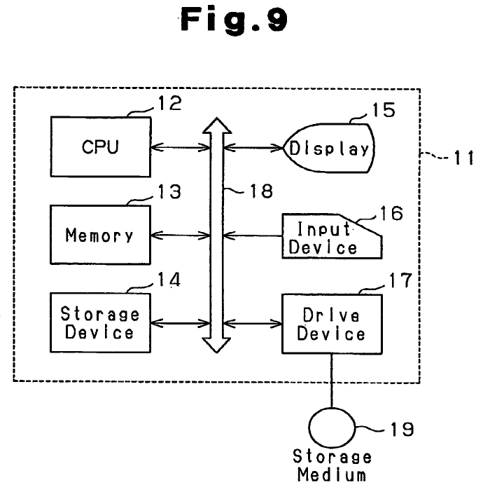

A layout device 11 according to a first embodiment of the present invention will now be described with reference to the accompanying drawings. FIG. 9 is a block diagram schematically showing the layout device 11.

The layout device 11 is a computer aided design (CAD) apparatus including a central processing unit (CPU) 12, a memory 13, a storage device 14, a display 15, an input device 16, and a driver 17 which are connected to one another by a bus 18.

The CPU 12 executes a program using the memory 13 and carries out processes required for layout designing and layout checking. The memory 13 stores programs and data required for implementing various functions such as a layout design function and a layout checking function. The memory 13 may be, for example, a cache memory, a system memory, or a display memory (none shown).

The display 15 may display a layout or a parameter input page. The display 15 may be, for example, a cathode ray tube (CRT), a liquid crystal display (LCD), or a plasma display panel (PDP) (none shown). The input device 16 may be, for example, a keyboard and mouse (none shown). A user (or designer) of the layout device 11 inputs requests, instructions, and parameters to the layout device 11 with the input device 16.

The storage device 14 may be, for example, a magnetic disk device, an optical disc device, or a magneto-optic disc device (none shown). The storage device 14 stores program data (hereinafter referred to as “programs”) used for layout design and design rule checks (DRC) and other various types of data files (hereinafter referred to as “files”). The CPU 12 transfers the programs or the data contained in the various files to the memory 13 in response to an instruction from the input device 16 and sequentially processes the programs or data. The storage device 14 is also used as a database.

The programs and layout data processed by the CPU 12 are provided by a storage medium 19. The driver 17 drives the storage medium 19 and accesses the contents stored in the storage medium 19. The CPU 12 reads a program from the storage medium 19 via the driver 17 and installs the program in the storage device 14.

The storage medium 19 may be any computer-readable storage medium such as a memory card, a flexible disk, an optical disc (e.g., CD-ROM and DVD-ROM) and a magneto-optic disc (e.g., MO and MD) (none shown). As an alternative, the above program may be stored in the storage medium 19 and loaded in the memory 13 for execution. Further, the storage medium 19 may be substituted by a network.

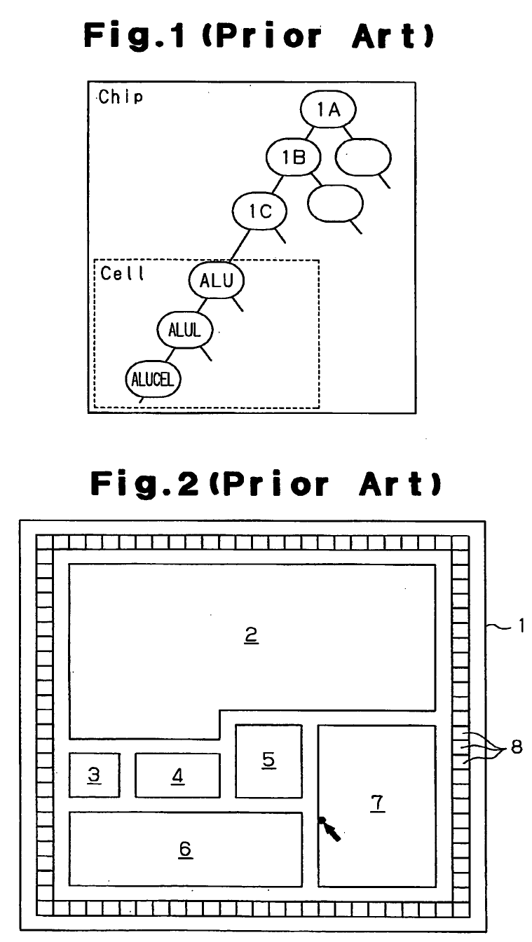

In the layout device 11 of the first embodiment, layout data for a semiconductor integrated circuit generated when designing a layout has a hierarchical structure as shown in FIG. 1. In the layout designing and layout checking, the hierarchical structure of data is taken into account in addition to position coordinates in a two-dimensional plane. The layout device 11 functions to dump and display position coordinates of a marked out pattern using coordinate system of any hierarchical level. Thus, the user (designer) may immediately correct an erroneous pattern located during a DRC by utilizing the dump function of the layout device 11.

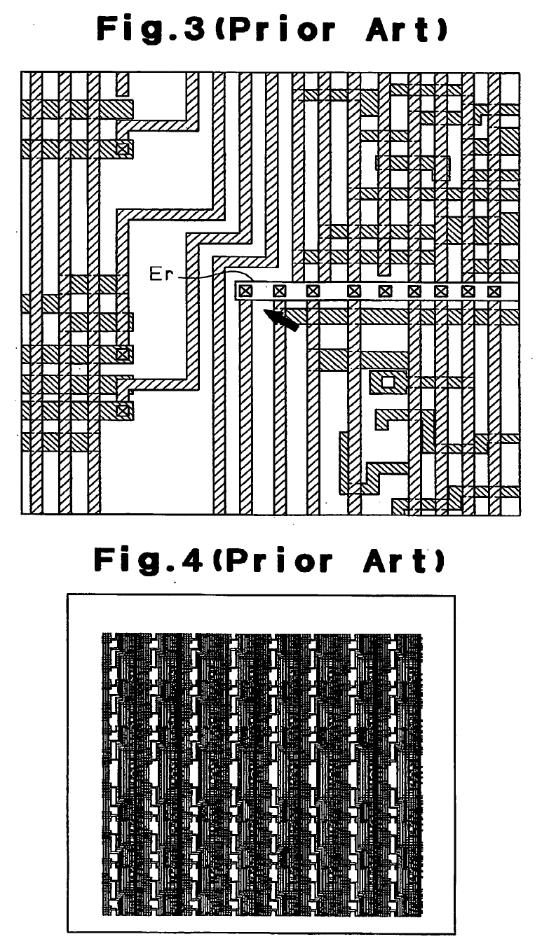

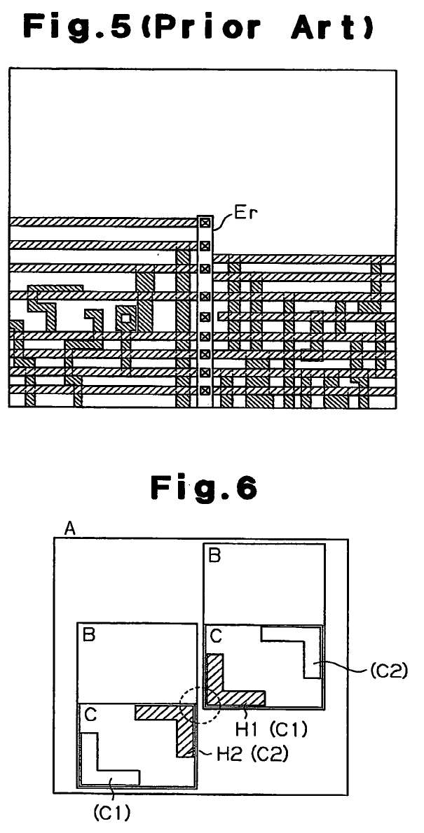

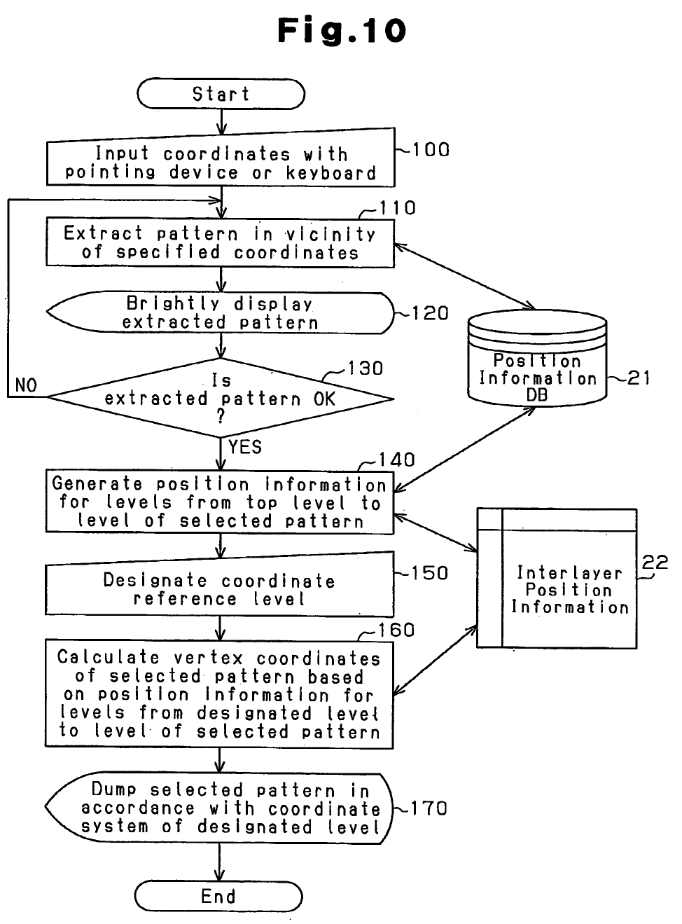

A display process for displaying a layout pattern in the layout device 11 will now be described in detail with reference to the flowchart of FIG. 10. A first file 21 and a second file 22 referred to in FIG. 10 are generated in the memory 13 shown in FIG. 9. The process of FIG. 10 starts when, for example, the user selects an erroneous pattern Er shown in a magnified state (refer to FIG. 3) on the display 15 with the mouse after carrying out the DRC.

In step 100, the CPU 12 retrieves coordinates specified by the user with a pointing device, such as the mouse, or the keyboard. Subsequently, in step 110, the CPU 12 refers to position information stored in the first file 21 to extract a pattern situated in the vicinity of the specified coordinates. The position information stored in the first file 21 includes a hierarchical reference table, which defines information relating to the hierarchical structure of layout data for patterns. The hierarchical reference table is generated when the CPU 12 reads the layout data resulting from the layout designing.

Then, in step 120, the CPU 12 displays the extracted pattern on the display 15 more brightly than other patterns. In step 130, the CPU 12 requests the user to confirm that the bright pattern is the pattern the user wishes to process. In this state, an “OK” button and an “NG” button are displayed on the screen of the display 15. When the user selects the “NG” button, the CPU 12 returns to step 110 and extracts a different pattern. Thereafter, the CPU 12 proceeds to step 120 and brightens the extracted pattern on the display 15.

When the user selects the “OK” button in step 130, the CPU 12 recognizes the extracted pattern as the pattern selected by the user (selected pattern) in step 140. Thereafter, the CPU 12 refers to the position information stored in the first file 21 to generate position information for hierarchical levels from the top level to the level to which the selected pattern belongs. The CPU 12 then stores inter-level position information in the second file 22. Afterwards, in step 150, the user uses the mouse to designate coordinates reference level (a hierarchical level of which coordinate system is used as a reference coordinate system). More specifically, the CPU 12 lists on the display 15 the names of a plurality of hierarchical levels in the range from the top level to the level to which the selected pattern belongs. Then, the user uses the input device 16 (e.g., the mouse) to select the name of the hierarchical level that is to be used as the reference coordinates level.

The CPU 12 retrieves the information that is input through the mouse operation. In step 160, the CPU 12 reads the position information of the hierarchical levels from the reference coordinates level designated by the user to the hierarchical level to which the selected pattern belongs from the second file 22. Then, the CPU 12 calculates the coordinates of each vertex of the selected pattern based on the read position information. Thereafter, in step 170, the CPU 12 dumps the coordinates of the selected pattern in accordance with the coordinate system of the reference coordinates level on the display 15. Afterwards, the CPU 12 ends the process.

FIG. 11 illustrates a specific example of a dump. When the erroneous pattern Er of FIG. 3 is selected, a main window W1 (FIG. 11) appears in the vicinity of the erroneous pattern Er in a manner overlapping the layout diagram of FIG. 3. The pattern selected as described above in the layout device 11 corresponds to the pattern marked out by the user (marked pattern).

The main window W1 shows a hierarchical tree route including an uppermost hierarchical level TOP, a middle hierarchical level MID, and a lower hierarchical level CEL. Further, the main window W1 shows information related to an Aref layout of the hierarchical level of the marked pattern (lower-hierarchical level CEL) in association with the middle hierarchical level MID. The Aref layout is a layout in which a pattern (in this case, the marked out erroneous pattern) is repetitively copied in X and Y axis directions.

More specifically, in the middle level MID, “[5/20]” and “[18/40]” indicate that twenty patterns of the lower level CEL are laid out along the X direction and forty patterns of the lower level CEL are laid out along the Y direction.

Further, “[5/20]” and “[18/40]” indicate that the fifth pattern in the X direction and the eighteenth pattern in the Y direction correspond to the marked pattern. The coordinates “(460.0000, 780.0000)” displayed on the right side of the numerals “[5/20]” and “[18/40]” are values of the layout origin coordinates of the marked pattern using the coordinate system of the top level TOP. On the right side of the coordinates, “PX/PY (750.0000, 880,0000)” indicate the interval of the patterns in the Aref layout in the X direction and the Y direction. The coordinates of each vertex is dumped in accordance with the coordinate system of the top level TOP as the information for the marked pattern at the lower level CEL. The user designates the middle level MID as the reference coordinates level with the mouse. As a result, a sub-window W2 differing from the main window W1 appears. The sub-window W2 shows the coordinates of each vertex of the marked pattern in accordance with the coordinate system of the middle level MID.

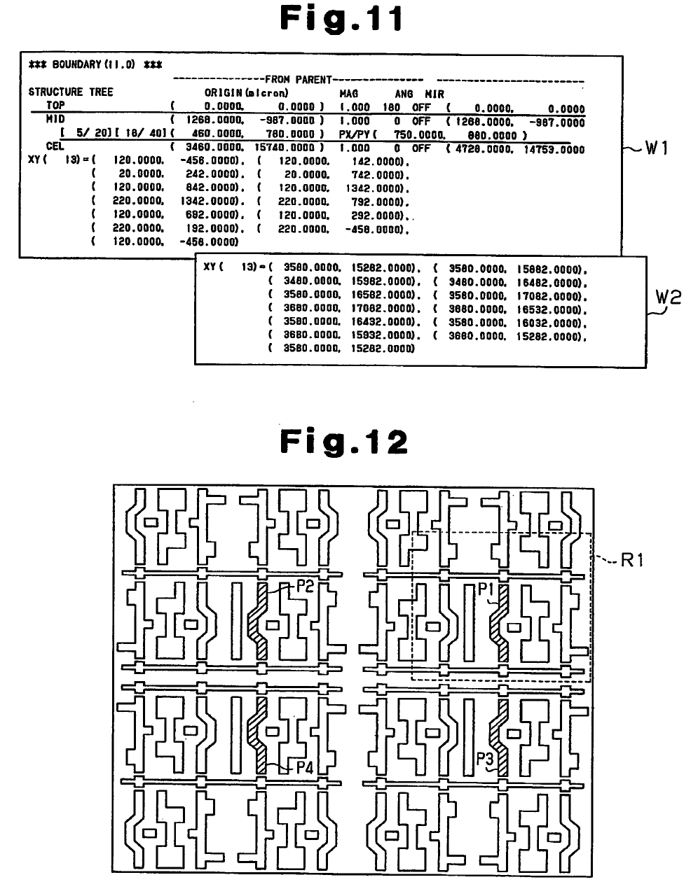

As described above, the hierarchical level of the marked pattern may include an Aref layout that includes the marked pattern. The hierarchical level of the marked pattern may be included in an Aref layout. Such a state is equivalent to a state in which the marked pattern is included in an Aref layout. In such cases, the layout device 11 may be provided with an additional function for changing column and row numbers of the marked pattern to change the image shown on the screen to a copied pattern of the marked pattern, which is identical to and separated from the marked pattern. This function allows acquisition of the position coordinates for every pattern in the hierarchical level of the marked pattern. Referring to FIG. 12, the patterns identical to the marked pattern P1 are obtained from the position coordinates of the patterns. After the marked pattern P1 is corrected, for example, the user may sequentially select patterns P2, P3 and P4, which are identical to the marked pattern P1 and affected by the correction of the marked pattern P1. This enables the user to check all of the patterns P1, P2, P3 and P4.

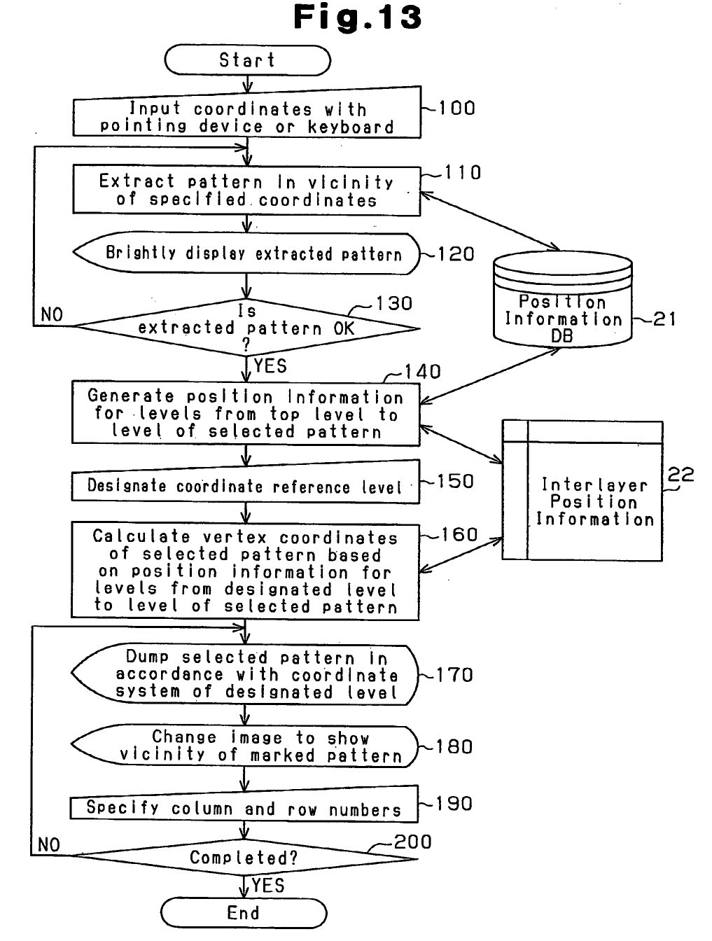

If the layout device 11 is provided with the above-described image changing function, steps 180 to 200 shown in FIG. 13 are additionally performed following the process of step 170. Steps 100 to 170 shown in FIG. 13 are identical to those shown in FIG. 10.

In step 180, the CPU 12 changes the image on the screen to the vicinity of the marked pattern. Subsequently, in step 190, the image is magnified and the marked pattern is colored differently from the surrounding patterns. In this state, the user locates the marked pattern. Thereafter, the user specifies column and row numbers of one pattern in the Aref layout with the mouse and keyboard. The CPU 12 retrieves the column and row numbers specified by the user. In step 200, the CPU 12 determines whether or not to end processing by detecting operations of the input device 16 by the user. It the CPU 12 determined not to end processing, the CPU 12 returns to step 170 and dumps the coordinates of the pattern corresponding to the specified number on the screen. Thereafter, in step 180, the CPU 12 changes the image on the screen to the marked pattern corresponding to the specified position number and its vicinity.

Then, in step 190, the CPU 12 waits for the user to input new column and row numbers. If the user operates the input device 16 to complete processing instead of inputting new numbers, the CPU 12 ends processing in step 200.

A case in which the marked pattern is in an Aref layout in the same hierarchical level has been described above. However, a hierarchical level for a hierarchical tree route that differs from the hierarchical tree route of the marked pattern may include an Sref layout (layout formed by a single copy of the marked pattern) or an Aref layout of the marked pattern. In the first embodiment, other hierarchical tree routes are selected to mark out patterns at other positions and obtain the coordinates of patterns at different locations. More specifically, when the marked pattern is copied (has a Ref layout) in a different hierarchical tree route, the CPU 12 refers to the hierarchical reference table in the first file 21 to search for information related to the Ref layout. Then, the hierarchical tree route of the presently marked out pattern and the different hierarchical tree route are shown in the main window W1. If the user selects the different hierarchical tree route, the CPU 12 dumps the newly marked out pattern of the different hierarchical tree route and displays the newly marked pattern and its vicinity.

The layout device 11 is also provided with a function for conducting localized DRC in the vicinity of the marked pattern based on the position information of each pattern used when changing an image on the screen. The layout device 11 carries out localized DRC in the following manner.

First, the user uses the mouse to designate a marked pattern and the range that is to be checked (e.g., range R1 indicated by the broken line in FIG. 12). The CPU 12 retrieves position information of the marked pattern and information for the check range. The information for the check range includes data represented as an offset amount from an initial point of the marked pattern. The CPU 12 performs localized DRC within the check range based on the position information.

In some cases, the marked pattern may be arranged in an Aref layout or in a Ref layout included in another hierarchical tree route. In such a case, in the same manner as when changing the image of the screen, the CPU 12 acquires the position information of the marked pattern and performs localized DRC at every location of the related patterns. If an error is not detected in any location during the DRC, the CPU 12 shows the word “NO ERROR” on the display 15. If an error is detected, the image of the screen is changed to show the erroneous pattern in a brightened state.

The layout device 11 of the first embodiment has the advantages described below.

(1) The layout device 11 dumps the coordinates for an erroneous pattern (marked pattern) in accordance with the coordinate system of any hierarchical level without changing the hierarchical level that is being displayed. This allows a user to accurately acknowledge the erroneous pattern without any human errors and shortens the time required for correction of the error.

(2) The main window W1 of FIG. 11 shows the layout origin, the quantity of columns and rows, the layout interval in the columns and rows, and the column and row number of the presently marked out pattern in the middle level MID of the hierarchical tree route as the detailed information of the marked pattern. Accordingly, the user may accurately identify the layout profile of the marked pattern based on the contents displayed in the main window W1.

(3) When the marked pattern is in an Aref layout, the column and row number is changed to switch the image shown on the screen to the vicinity of a pattern corresponding to the switched column and row number. Accordingly, the user may visually check patterns in the Aref layout in addition to the pattern of which error has been corrected. This enables the user to easily check the effects of an error correction.

(4) When the marked pattern is in a Ref layout in a hierarchical tree route differing from that of the marked pattern, a search is conducted to locate all of the patterns in the Ref layout. Subsequently, the coordinates for each pattern are obtained, and the image on the screen image is changed based on the obtained coordinates. Accordingly, the user may visually check all of the patterns in the Ref layout in addition to the corrected pattern. In this manner, the user may easily check the effects of a correction.

(5) After an error in a marked pattern is corrected, localized DRC is carried out on all of the patterns in the Ref layout of the marked pattern. Accordingly, error detection is focused in a range affected by the error correction. This reduces the amount of layout data that is to be checked and shortens the DRC processing time in comparison to when the DRC is carried out on an entire chip.

### Second Embodiment

A layout device 11 according to a second embodiment of the present invention will now be discussed with reference to the drawings.

Layout data for a semiconductor integrated circuit that is generated during layout designing has a hierarchical structure as shown in FIG. 1. When performing layout designing and checking, in addition to coordinates on a two dimensional plane, the hierarchical structure is also taken into consideration. The layout device 11 of the second embodiment has a function for dump displaying the coordinate of a marked pattern based on the coordinate system of an arbitrary hierarchical level. Further, the layout device 11 functions to sort the hierarchical tree routes of a plurality of marked patterns to extract a hierarchical structure and display a hierarchical tree. The user (designer) uses this function to quickly correct an erroneous pattern detected through DRC.

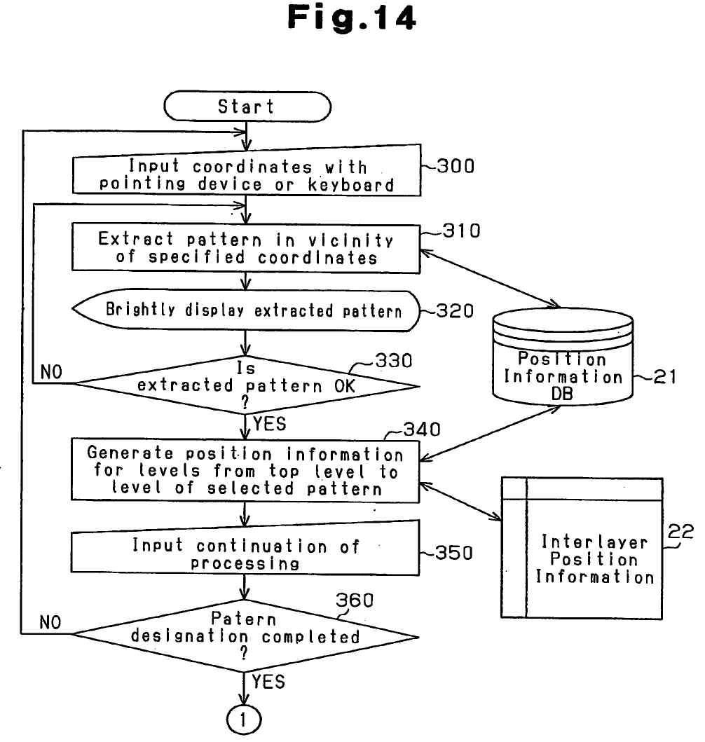

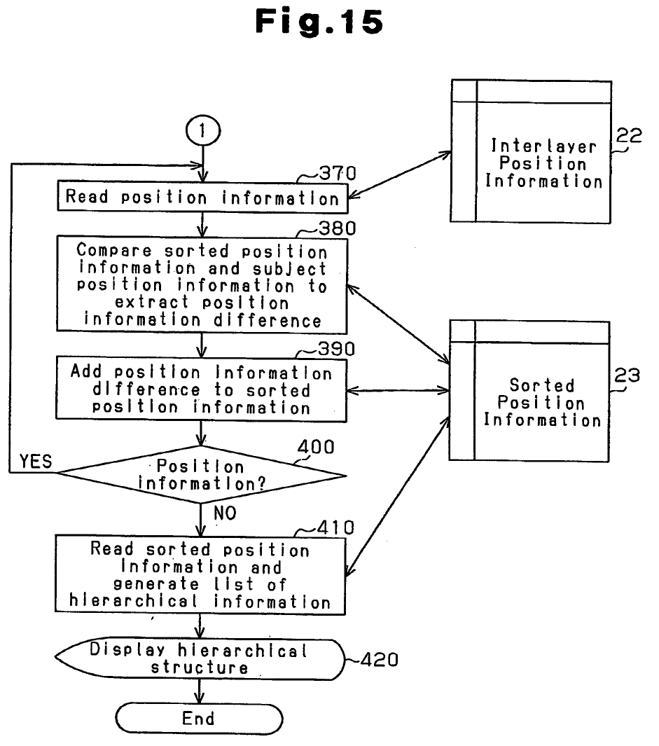

A hierarchical tree display process performed by the layout device 11 will now be discussed with reference to FIGS. 14 and 15. First, second, and third files 21, 22, and 23, which are shown in FIGS. 14 and 15, are generated in the memory 13 of FIG. 9. The processing of FIGS. 14 and 15 starts, for example, after DRC when the user selects erroneous patterns C1 and C2 (refer to FIG. 6), which are zoomed in on a display 16, with a mouse.

In step 300, the CPU 12 retrieves a coordinate specified by a pointing device, such as a mouse, or a keyboard. Afterwards, in step 310, the CPU 12 refers to the position information stored in the first file 21 to extract the position information of a pattern in the vicinity of the specified coordinate. The position information of the first file 21 includes a hierarchical level reference table defining information related with the hierarchical structure of pattern data. The hierarchical level reference table is generated when the CPU 12 reads layout data generated when layout designing is performed.

In step 320, the CPU 12 shows the extracted pattern on a display 15 with a brightness that is greater than the other patterns. In step 330, the CPU 12 asks the designer whether the bright pattern is the selected pattern. In this state, an OK button and an NG button are shown on the display 15. In step 330, when determining that the user selected the NG button, the CPU 12 returns to step 310 and extracts another pattern. Afterwards, the CPU 12 proceeds to step 320 and shows another extracted pattern via brightness level.

When determining that the user selected the OK button in step 330, the CPU 12 recognizes the extracted pattern as a pattern selected by the user (selected pattern) in step 340. The CPU 12 refers to the position information of the first file 21 to generate position information for hierarchical levels from the uppermost hierarchical level to the hierarchical level to which the selected pattern belongs and stores the position information of the hierarchical level in the second file 22.

In step 350, the CPU 12 asks the user whether other patterns should be selected. In this state, an OK button and an NG button are shown on the display 15. In step 360, when determining that the user selected the OK button, the CPU 12 returns to step 300 and retrieves a coordinate specified by a pointing device, such as a mouse, or a keyboard. The CPU 12 repeats steps 310 to 340 to store position information related to the selected pattern in the second file 22.

In step 360, when determining that the user selected the NG button, the CPU 12 proceeds to step 370, which is shown in FIG. 15, and reads a piece of position information (subject position information) from the second file 22. Then in step 380, the CPU 12 reads sorted position information from the third file 23 and compares the sorted position information with the subject position information. The CPU 12 extracts information of the difference between the sorted position information and the subject position information (difference position information). More specifically, the CPU 12 deletes position information that is common between the subject position information and the sorted position information (common position information) from the subject position information to generate the difference position information. Then, in step 390, the CPU 12 adds the extracted difference position information to the sorted position information. Accordingly, the third file 23 stores sorted position information that includes the extracted difference position information.

In step 400, the CPU 12 determines whether there is position information that has not been read from the second file 22. When there is position information that has not been read, the CPU 12 returns to step 370, extracts the difference position information of the next position information, and adds the difference position information to the sorted position information.

In step 400, when determining that all information has been read from the second file 22, the CPU 12 proceeds to step 410 and reads the sorted position information from the third file 23 to generate a list of the hierarchical structure. If the user designates the display of a hierarchical levels that are in a parent hierarchical level or a lower level, the CPU 12 obtains the common parent hierarchical level from an all hierarchical structure list. The CPU 12 deletes position information of hierarchical levels higher than the common parent hierarchical level from the hierarchical structure list. Then, in step 420, the CPU 12 shows a hierarchical tree of the hierarchical structure list on the display 15.

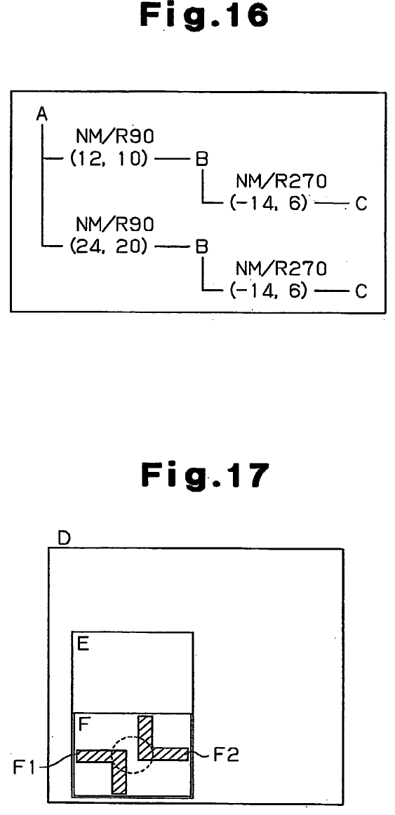

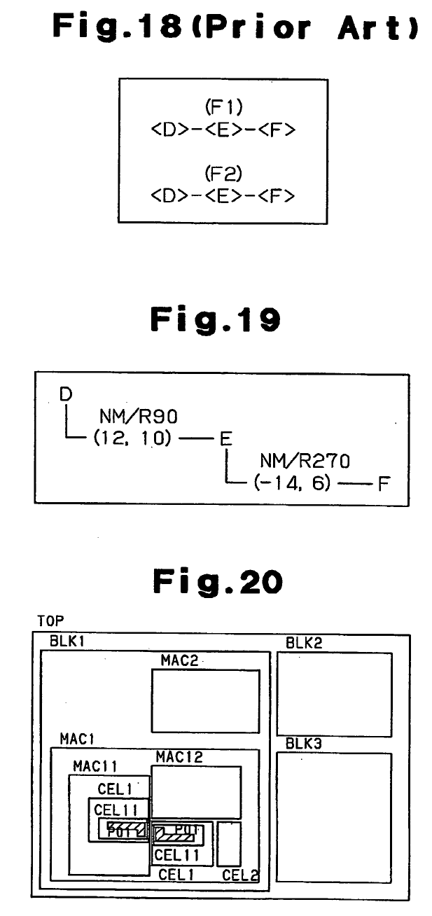

More specifically, when erroneous patterns C1 and C2 belong to different hierarchical tree routes as shown in FIG. 6, position routes branching from a common hierarchical level are displayed as shown in FIG. 16. When erroneous patterns F1 and F2 belong to the same hierarchical tree route as shown in FIG. 17, a single position route is displayed as shown in FIG. 19. Thus, the user may easily determine whether an erroneous pattern belongs to different hierarchical tree routes (refer to FIG. 16) or the same hierarchical tree route (refer to FIG. 19). Conversely, in the prior art, the position route is displayed as shown in FIG. 18. Accordingly, in comparison to the displaying method in the prior art, the displaying method of the second embodiment enables the hierarchical tree route of an erroneous pattern to be easily recognized. Further, the user can easily compare position information (coordinates, rotation, mirror image) by referring to the hierarchical tree display. Thus, the user does riot have to trace each route hierarchical level as shown in FIGS. 8A and 8B.

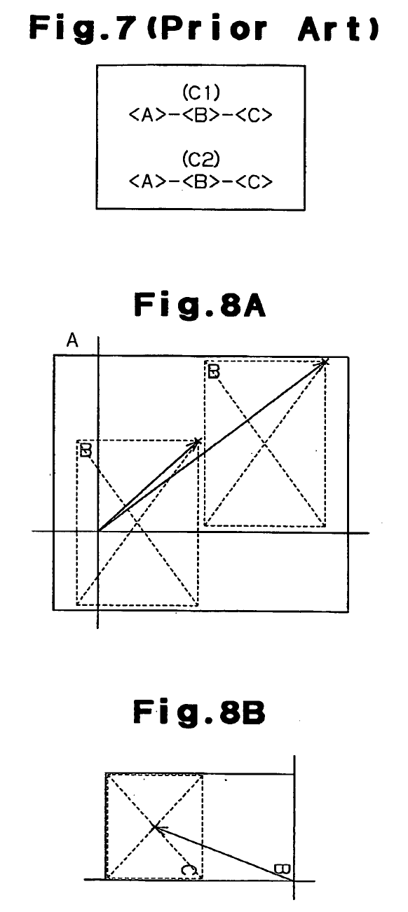

Different hierarchical tree routes have different position information for route hierarchical levels. In the hierarchical tree display of FIG. 16, the two Cs at the end of the hierarchical tree routes indicate that the erroneous patterns C1 and C2 belong to hierarchical levels C, which have the same configuration. Further, in the hierarchical tree display, two hierarchical levels B are arranged under the uppermost hierarchical level A. The two hierarchical levels B have different position information. Thus, it is apparent that the erroneous patterns C1 and C2 belong to different hierarchical tree routes. Additionally, the position information of the erroneous patterns C1 and C2 clearly shows the difference in coordinates. The position route of pattern C1 shows the position coordinate (12, 10) of hierarchical B, which is lower than hierarchical level A. The position route of pattern C2 shows the position coordinate (24, 20) of hierarchical B. Conversely, in the display of the prior art such as that shown in FIG. 7, when the two route hierarchical level names of the erroneous patterns C1 and C2 are the same, the user must separately search for position information to check the position information. The burden of such searching and checking is eliminated in the second embodiment as described above.

In the example described above, there is a difference only in coordinates for the position information. When there is a difference in rotation or mirror image, the difference in rotation or mirror image is clearly shown by the hierarchical tree display. Thus, the user may easily determine whether or not hierarchical tree routes match. When there is no problem in the coordinates of the erroneous patterns, the user must check the accuracy of the position information for the two hierarchical levels B under hierarchical level A and the accuracy of the position information for one hierarchical level C under each hierarchical level B. The user may easily obtain the position information from the hierarchical tree display of the layout device 11.

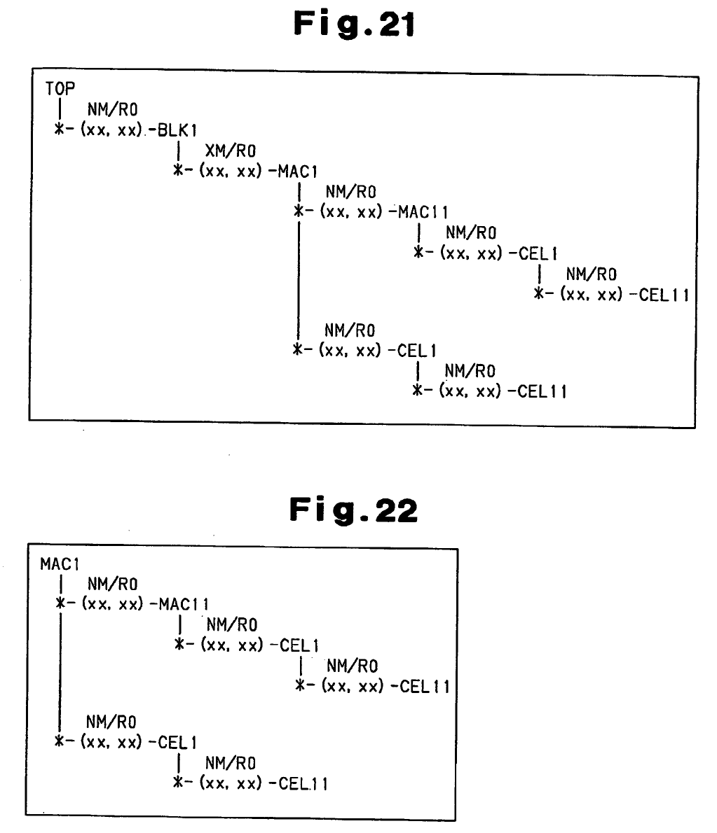

Further, the layout device 11 may be provided with a function for displaying a hierarchical tree by eliminating common portions of a plurality of patterns (shortened display function). For example, as shown in FIG. 20, two patterns CEL11 have a common parent hierarchical level MAC1, which is included in a higher hierarchical level. In this case, as shown in FIG. 21, a hierarchical tree showing hierarchical levels from the uppermost hierarchical level to the hierarchical level of the selected pattern CEL11 is shown.

The range in which accuracy must be checked is the hierarchical levels that are lower than the common hierarchical level MAC1. Thus, as shown in FIG. 22, a layout device provided with the shortened display function searches for the common parent hierarchical level MAC1 and displays the parent hierarchical level MAC1 and lower hierarchical levels. In this display, the user does not see the matching portions from the beginning. Thus, the user docs not have to check the accuracy of unnecessary portions.

When a plurality of erroneous patterns belong to the same hierarchical tree route, the values in the position information of route hierarchical levels are the same. In the hierarchical tree display of FIG. 19, the F at the end of the hierarchical tree route indicates that the erroneous patterns F1 and F2 belong to the same hierarchical level F. In the prior art display (refer to FIG. 18), the two hierarchical level names obtained from the erroneous patterns F1 and F2 are the same. However, to determine that the position routes of the erroneous patterns F1 and F2 are the same, the position information must be separately searched to check the matching of hierarchical tree routes. In comparison, in the hierarchical tree display of the second embodiment, one hierarchical level F is shown at the end of the hierarchical tree route. Thus, the user may recognize whether erroneous patterns belong to the same hierarchical tree route.

Accordingly, when locating the cause of an error, the user only has to check whether there is a problem in the coordinates (position and shape) of erroneous patterns F1 and F2 and does not have to check the accuracy of the position information for route hierarchical levels.

In addition to the advantages of the first embodiment, the layout device 11 of the second embodiment has the advantages described below.

The layout device 11 sorts the position information of a plurality of patterns and displays a hierarchical tree of hierarchical levels from a common hierarchical level of the patterns to the hierarchical level of the selected pattern (erroneous pattern). Thus, the user may determine whether or not the position tree routes of the patterns match. When the hierarchical tree routes do not match, the user can check the accuracy of position information without performing separate searching of the position information, such as changing the layout-displayed hierarchical levels. Thus, the cause of errors can accurately be checked without the occurrence of human errors. This reduces the time for correcting the erroneous patterns.

### Third Embodiment

A layout device 11 according to a third embodiment of the present invention will now be described with reference to the drawings.

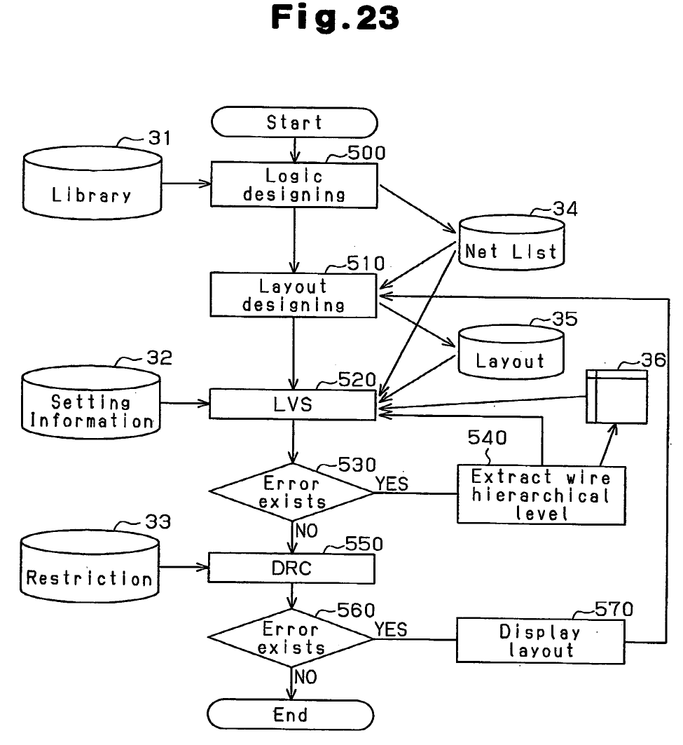

FIG. 23 is a schematic flowchart of a designing process perforated by the layout device 11, which functions as a designing device.

As shown in FIG. 9, in the same manner as the above embodiment, the layout device 11 is a computer aided design (CAD) apparatus including a central processing unit (CPU) 12, a memory 13, a storage device 14, a display 15, an input device 16, and a driver 17 that are connected to one another by a bus 18.

The layout device 11 generates a net list and layout data for a large scale semiconductor integrated circuit device (e.g., LSI and VLSI) in accordance with a flowchart shown in FIG. 23. The layout device 11 checks the generated layout data. In the third embodiment, the layout device 11 performs design rule check (DRC) and layout versus schematic (LVS) as the checking. More specifically, the storage device 14 of FIG. 9 stores program data and various data files for logic designing, layout designing, DRC, and LVS. The CPU 12 transfers the stored data of the programs and the files to the memory 13 and performs processing accordingly.

As shown in FIG. 23, the layout device 11 refers to first to third files 31 to 33 stored in the storage device 14. Then, the layout device 11 stores a fourth file 34 and a fifth file 35 in the storage device 14. The layout device 11 stores a sixth file 36 in the memory 13.

The first file 31 stores library data, such as macros and cells. The second file 32 stores setting information for performing LVS. The setting information includes rules for identifying a transistor, a wire capacitance parameter, and information of hierarchical levels for extracting wires. The third file 33 stores restriction information for performing DRC. The restriction information includes wire intervals and wire widths.

In step 500, the layout device 11 refers to the library of the first file 31 based on a specification to perform logic designing (circuit designing). The layout device 11 stores circuit connection data (net list) generated during logic designing in the fourth file 34.

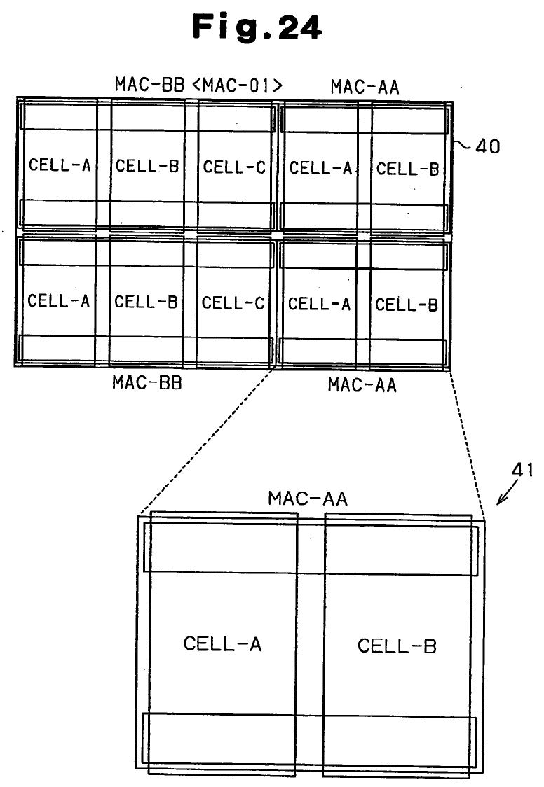

In step 510, the layout device 11 refers to the library of the first file 31 to perform layout designing of the semiconductor device based on the net list of the fourth file 34. The layout device 11 stores layout data that is generated during layout designing in the fifth file 35. The layout data includes position information of a cell structure and has a hierarchical structure as shown in FIG. 24.

In step 520, the layout device 11 performs LVS. More specifically, the layout device 11 refers to the library data of the first file 31 and the setting information of the second file 32 to generate connection information from the layout data. The connection information indicates a plurality of elements (terminals) set at the same potential. The layout device 11 compares the connection information with the net list of the fourth file 34 to generate error information showing nets that do not match.

Then, in step 530, the layout device 11 determines whether there is an error based on the LVS result. The layout device 11 proceeds to step 540 when there is an error and proceeds to step 550 when there is no error.

In step 540, the layout device 11 performs a position information generation process to generate position information of hierarchical levels from an uppermost hierarchical level of a pattern in which an error is detected (erroneous pattern) to a hierarchical level to which a selected pattern belongs. Based on the position information between hierarchical levels, the layout device 11 generates information of hierarchical layers including wires searched through LVS and stores the hierarchical layer information in the sixth file 36. During the position information generation process, the layout device 11 performs substantially the same processing as steps 110 to 140 of the first embodiment. The coordinate of a pattern in which an error is detected (erroneous pattern) during LVS is reported using the coordinate system of the uppermost hierarchical level in a chip.

Then, in step 520, the layout device 11 generates connection information from wires searched based on the hierarchical level information stored in the sixth file 36. This resolves errors that occur when different wires belong to different hierarchical levels.

With regard to cases in which a plurality of wires belong to different hierarchical levels, an example of a power supply wire will now be described.

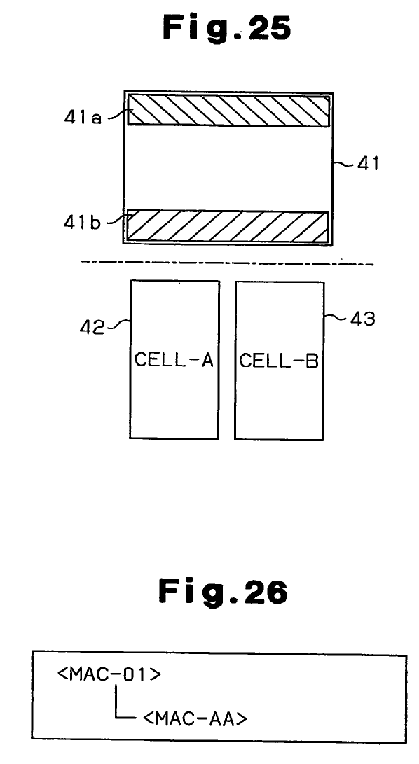

FIG. 24 shows a cell structure 40 having a hierarchical structure. The cell structure 40 includes a macro 41 defined in hierarchical level <MAC-01>. The macro 41 includes two cells 42 and 43 defined in hierarchical level <MAC-AA>. Furthermore, referring to FIG. 25, the macro 41 includes power supply wires 41a and 41b, which are defined in hierarchical level <MAC-AA> and connected to the cells 42 and 43. The cell 42 includes information of a contact pattern (not shown) defined in hierarchical level CELL-A and connected to the power supply wires 41a and 41b. In the same manner, the cell 43 includes information of a contact pattern (not shown) defined in hierarchical level CELL-B and connected to the power supply wires 41a and 41b. The power supply wires 41a and 41b are included in hierarchical level <MAC-AA>. Accordingly, the hierarchical level information of the power supply wires 41a and 41b are tree-displayed as shown in FIG. 26. The tree display is generated through the processing of the second embodiment.

The setting information stored in the second file 32 shown in FIG. 23 includes hierarchical level information for extracting wires included between the uppermost hierarchical level and hierarchical level <MAC-AA>. The layout device 11 extracts the wires of hierarchical level. <MAC-AA> based on the hierarchical level information and generates connection information based on the extracted wires.

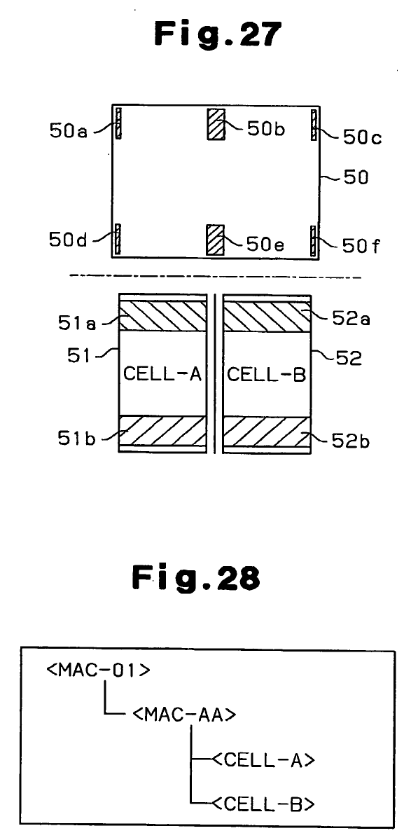

The macro 41 and the cells 42 and 43 shown in FIG. 25 are generated in accordance with one rule. FIG. 27 shows a macro 50 and cells 51 and 52 generated in accordance with a further rule. The cell 51 includes power supply wires 51a and 51b defined in hierarchical level CELL-A. In the same manner, the cell 52 includes power supply wires 52a and 52b defined in hierarchical level CELL-B. The macro 50 includes power supply wires 50a to 50f defined in hierarchical level <MAC-AA>. The power supply wires 50a to 50f are auxiliary wires for connecting power supply wires 51a, 51b, 52a, and 52b of the cells 51 and 52, and the other power supply wires. The macro 50 and the cells 51 and 52 generated in accordance with the further rule are generated by a tool differing from that of the macro 41 and the cells 42 and 43 of FIG. 25. The macro 50 and the cells 51 and 52 may be provided as IP macro.

The layout device 11 generates an error when performing LVS on layout data that is generated by using the macro 50 shown in FIG. 27. That is, the layout device 11 generates an error in which a power supply wire is not connected to cells 51 and 52 and an error in which the power supply wires 50b and 50e of the macro 50 are not connected to anywhere. However, in a semiconductor device (LSI) fabricated by using the macro 50 of FIG. 27, the power supply wires 51a, 51b, 52a, and 52b of the cells 51 and 52 is actually electrically connected to the power supply wires 50a to 50f of the macro 50. Therefore, there is substantially no problem in a semiconductor device that includes the macro 50 and the cells 51 and 52. In other words, the result of LVS performed in accordance with the setting information stored in the second file 32 includes an error that does not cause a substantial problem.

The macro 50 shown in FIG. 27 is displayed by the tree display process of the second embodiment as shown FIG. 28. When comparing the tree display of FIG. 28 with the tree display of FIG. 26, the difference between two macros 41 and 50 is clearly shown.

Based on the coordinates of a pattern detected as having an error during LVS, the layout device 11 generates hierarchical level information of a pattern located at those coordinates. For example, the layout device 11 acquires position information of patterns in the vicinity of patterns where errors were detected, that is, the position information of the power supply wires 51a, 51b, 52a, and 52b. Then, based on the position information of the power supply wires 51a, 51b, 52a, and 52b, the layout device 11 generates position information of the hierarchical levels from the uppermost hierarchical level to the hierarchical level in which the power supply wires 51a, 51b, 52a, and 52b are located. Based on the position information of the hierarchical levels from the uppermost hierarchical level to the hierarchical level in which the power supply wires 51a, 51b, 52a, and 52b are located, the layout device 11 stores the hierarchical level information that is to be searched through LVS in the sixth file 36 shown in FIG. 23. In other words, the layout device 11 generates hierarchical level information so that the hierarchical level including the power supply wires 51a, 51b, 52a, and 52b shown in FIG. 27 are searched during LVS. In other words, the hierarchical information stored in the sixth file 36 includes information indicating that wires belonging to different hierarchical levels are actually (physically) connected.

In step 520, the layout device 11 generates connection information from the wires extracted based on the generated hierarchical level information. The generated connection information includes the connection relationship of the power supply wires 51a, 51b, 52a, and 52b shown in FIG. 27. Accordingly, the LVS result of the layout device 11 does not include errors related with the connection relationship of the power supply wires 51a, 51b, 52a, and 52b. The result of the LVS using the hierarchical level information stored in the sixth file 36 differs from the result of the LVS performed in accordance with the setting information stored in the second file 32 and includes only errors that are substantial problems. This decreases the number of errors included in the LVS result and significantly reduces the checking time and correcting time required by the user (designer). The user does not have to check errors that do not cause substantial problems. This reduces the possibility of overlooking errors that would cause substantial problems. Further, the number of times LVS is performed is reduced. This shortens the designing time.

In step 550, the layout device 11 performs DRC. More specifically, the layout device 11 checks the layout data of the fifth file 35 based on the restriction information of the third file 33. The layout device 11 generates error information indicating locations (wires) violating the restriction information.

In step 560, the layout device 11 determines whether or not there is an error based on the result of DRC. The layout device 11 proceeds to step 570 when there is an error and ends the designing process when there is no error.

In step 570, the layout device 11 of the third embodiment 11 performs substantially the same process as the layout display process performed by the layout device 11 of the first embodiment. The layout device 11 provides a function for dumping the position coordinates of a marked out pattern with the coordinate system of an arbitrary hierarchical level. Further, the layout device 11 changes layout data based on the instruction of a user. Accordingly, the user may use the function to readily correct an erroneous pattern detected during DRC.

The layout device 11 of the third embodiment has the advantages described below.

The layout device 11 acquires the position information of patterns near the pattern where an error (electric wire) was detected. From the position information, the layout device 11 generates position information of hierarchical levels from the uppermost hierarchical level to the hierarchical level in which power supply wires are located. Based on the position information, the layout device 11 then stores the hierarchical level information that is to be searched during LVS in the sixth file 36 of FIG. 23. In step 520, the layout device 11 performs LVS based on the generated hierarchical level information. As a result, an error resulting from a wire being located in a hierarchical level differing from the setting information in the earlier performed LVS does not include the result of LVS performed later. This decreases the number of errors included in the LVS result and significantly shortens the checking and correcting time required by the user. Further, the user (designer) does not have to check errors that do not cause substantial problems. This reduces the possibility of overlooking errors that cause substantial problems. In other words, errors resulting from the difference of hierarchical levels are easily eliminated. Further, it is easy to focus on errors that must be analyzed during layout checking. Further, the number of times LVS is performed is reduced. This shortens the designing time.

It should be apparent to those skilled in the art that the present invention may be embodied in many other specific forms without departing from the spirit or scope of the invention. Particularly, it should be understood that the present invention may be embodied in the following forms.

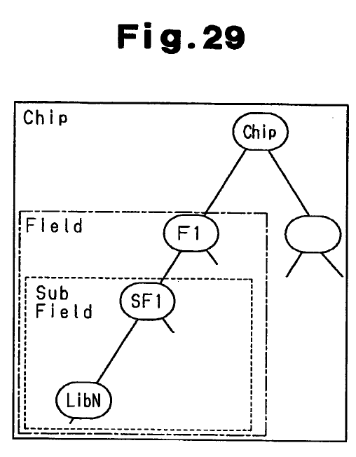

The layout device 11 of the first embodiment performs layout designing and layout checking of a semiconductor integrated circuit. However, the present invention is not limited to such use. For example, exposure data for a semiconductor photomask has a hierarchical structure as shown in FIG. 29. Thus, the present invention may also be applied to a layout device that performs pattern designing and pattern checking for a semiconductor photomask.

In the layout device 1i of the first embodiment, when the marked pattern is in an Aref layout, the user inputs column and row numbers to display the corresponding pattern and its vicinity. However, the present invention is not limited to such a procedure. For example, the displayed image may be sequentially changed to show patterns in the Aref layout when the user pushes a button (e.g., an “ENTER” key) for switching the image. Further, localized DRC may be carried out in accordance with an order corresponding to the position number of the Aref layout instead of an order specified by the user.

In step 570 of the third embodiment, the layout device 11 may perform the hierarchical tree display process of the second embodiment.

In the third embodiment, the present invention is embodied in the layout device 11 that generates and checks a net list and layout data. Instead, the present invention may be applied to a check device that reads a net list and layout data stored in a file and checks the net list and layout data.

In the third embodiment, the layout device 11 performs both DRC and LVS as the checking process for layout data. Instead, the layout device 11 may perform only DRC or only LVS. Further, the layout device 11 may perform an electrical rule check in lieu of LVS. The layout device 11 may also perform both LVS and ERC.

In the third embodiment, the layout device 11 stores the hierarchical level information extracted in step 540 in the sixth file 36. Instead, the layout device may store the hierarchical level information in the second file 32 by adding it to the setting information. Further, the layout device 11 may rewrite (update) the information of hierarchical levels in the second file 32 of wires that are to be searched.

In the third embodiment, the layout device 11 stores the sixth file 36, which stores hierarchical level information extracted in step 540, in the memory 13. Instead, the layout device 11 may store the sixth file 36 in the storage device 14.

The present examples and embodiments are to be considered as illustrative and not restrictive, and the invention is not to be limited to the details given herein, but may be modified within the scope and equivalence of the appended claims.

1. A layout device for designing a layout by a user for a plurality of patterns using pattern data having a hierarchical structure, the device comprising:
a storage unit for storing position information of the patterns generated through the designing of the layout;
a display unit for displaying the patterns in accordance with a layout corresponding to the position information;
an input unit for enabling the user to designate a pattern from one of the patterns displayed on the display unit as a marked pattern and enabling the user to designate a hierarchical level for the hierarchical structure to which the marked pattern belongs as a reference level; and
a processing unit, connected to the storage unit, the display unit, and the input unit, for obtaining coordinates of the marked pattern using the position information of the patterns in the reference level that is stored in the storage unit and dumping the obtained coordinates to the display unit.

2. The layout device according to claim 1, wherein the processing unit displays a layout origin, a quantity of columns and rows, an interval between patterns in columns and rows, and column and row numbers for each hierarchical level in the hierarchical structure of the marked pattern as detailed information of the marked pattern on the display unit.

3. The layout device according to claim 2, wherein the input unit enables the user to change the column and row numbers, and when the marked pattern has copied patterns in the hierarchical structure of the marked pattern and the user changes the column and row numbers, the processing unit displays the pattern corresponding to the changed column and row numbers on the display unit based on the detailed information of the marked pattern.

4. The layout device according to claim 2, wherein the position information stored in the storage unit includes a hierarchical reference table for defining information related to the hierarchical structure, and when a marked pattern has copied patterns in a hierarchical structure differing from that of the marked pattern, the processing unit refers to the hierarchical reference table to search for the copied patterns, the display unit displaying a pattern corresponding to coordinates related with information of the searched copied patterns.

5. The layout device according to claim 4, wherein the processing unit locally conducts a design rule check on a pattern corresponding to the marked pattern based on the position information.

6. The layout device according to claim 1, wherein the processing unit refers to the position information to generate inter-level position information of hierarchical levels between an uppermost hierarchical level and the hierarchical level of the marked pattern and displays a plurality of hierarchical levels between the uppermost hierarchical level and the hierarchical level of the marked pattern in a manner in which one of the hierarchical levels is selectable to the user as a reference level.

7. A layout device for designing a layout by a user for a plurality of patterns using pattern data having a hierarchical structure, the device comprising:
a storage unit for storing position information of the patterns generated through the designing of the layout;
a display unit for displaying the patterns in accordance with a layout corresponding to the position information;
an input unit for enabling the user to designate a pattern from one of the patterns displayed on the display unit as a marked pattern and enabling the user to designate a hierarchical level of the hierarchical structure to which the marked pattern belongs as a reference level; and
a processing unit, connected to the storage unit, the display unit, and the input unit, for obtaining coordinates of the marked pattern using the position information of the patterns in the reference level that is stored in the storage unit and dumping the obtained coordinates to the display unit, wherein
the processing unit displays a layout origin, a quantity of columns and rows, an interval between patterns in columns and rows, and column and row numbers for each hierarchical level in the hierarchical structure of the marked pattern as detailed information of the marked pattern on the display unit, and the processing unit displays a sub-window showing the coordinates of the marked pattern in accordance with a coordinate system for the reference level on the display unit.

8. The layout device according to claim 7, wherein the processing unit locally conducts a design rule check on the marked pattern and a checking range designated by the input unit.

9. The layout device according to claim 1, wherein:
the storage unit stores a plurality of hierarchical structures; and
the processing unit uses position information of the plurality of hierarchical structures stored in the storage unit to display on the display unit a tree indicating the hierarchical structures and the position information.

10. The layout device according to claim 9, wherein the processing unit searches for a common parent hierarchical level in the stored hierarchical structures and displays on the display unit a tree including hierarchical levels from the common parent hierarchical level to the hierarchical level to which a plurality of marked patterns belong.

11. The layout device according to claim 10, wherein the processing unit displays a tree having a single route when the plurality of marked patterns belong to the same hierarchical level and displays a tree having a route branched from the common parent hierarchical level when the plurality of marked patterns belong to different hierarchical levels.

12. A layout device for designing a layout for a plurality of patterns using pattern data having a hierarchical structure, wherein the hierarchical structure includes hierarchical levels, each including a wire, the device comprising:
a storage unit for storing position information of the patterns generated through the designing of the layout;
a check unit for checking the layout of the plurality of patterns by searching for the wire included in a predetermined one of the hierarchical levels based on the position information and generating connection information from information of the wire;
a setting unit for setting a marked pattern from the plurality of patterns based on the checking result of the layout;
a hierarchical structure storage unit for storing the hierarchical structure to which the marked pattern belongs;
a hierarchical information extraction unit for generating information of the hierarchical level including the wire that is to be searched by the check unit based on the position information of the hierarchical structure stored in the hierarchical structure storage unit, wherein the test unit retests the layout based on the information of the hierarchical level including the wire that is to be searched.

13. The layout device according to claim 12, wherein the hierarchical information extraction unit generates information indicating a connection relationship of the wires included in different hierarchical levels.

14. A layout method for aiding a user in processing a layout to perform layout designing of a plurality of patterns using pattern data having a hierarchical structure, the method comprising:
reading position information of the patterns generated through the layout designing;
displaying the patterns in accordance with a layout corresponding to the position information;
designating a pattern from the patterns as a marked pattern in accordance with a first input from the user;
designating a hierarchical level of the hierarchical structure of the marked pattern as a reference level in accordance with a second input from the user;
obtaining coordinates of the marked pattern using the position information of the patterns in the reference level; and
dumping the obtained coordinates to the display unit.

15. The layout method according to claim 14, further comprising:
displaying a plurality of hierarchical levels between an uppermost hierarchical level and the hierarchical level of the marked pattern to enable the user to select one of the levels.

16. The layout method according to claim 14, further comprising:
displaying a layout origin, a quantity of columns and rows, an interval between patterns in columns and rows, and column and row numbers for each hierarchical level in the hierarchical structure of the marked pattern on the display unit.

17. The layout method according to claim 16, further comprising:
changing the columns and row numbers in accordance with a third input from the user; and
displaying a pattern corresponding to the changed column and row number on the display unit.

18. The layout method according to claim 14, further comprising:
conducting a design rule check locally on a pattern corresponding to the marked pattern.

19. The layout method according to claim 14, further comprising:
storing a plurality of hierarchical structures;
reading position information of all of the stored hierarchical structures;
sorting the position information to obtain a relationship between all of the stored hierarchical structures; and
displaying a tree indicating the relationship of all of the stored hierarchical structures.

20. A layout method for performing layout designing of a plurality of patterns using pattern data having a hierarchical structure, wherein the hierarchical structure includes hierarchical levels, each including a wire, the method comprising:
storing position information of the patterns generated through the layout designing;
searching for a wire included in a predetermined hierarchical level based on the position information;
testing the layout by generating connection information from information of the wire;
setting a pattern of the plurality of patterns as a marked pattern based on the result of the layout check;
storing the hierarchical structure to which the marked pattern belongs;
generating information of the hierarchical level including the wire that is to be searched based on the position information of the stored hierarchical structure; and
retesting the layout based on the information of the hierarchical level including the wire that is to be searched.

21. The layout method according to claim 20, wherein said generating information of the hierarchical level including the wire that is to be searched includes generating information indicating a connection relationship of the wires included in different hierarchical levels.

22. A computer program product for use by a user, comprising a storage medium encoding computer-readable instruction steps for designing a layout of a plurality of patterns using pattern data having a hierarchical structure, the instruction steps when executed by a computer performs steps including:
reading position information of the patterns generated through the designing of the layout;
displaying the patterns in accordance with a layout corresponding to the position information;
designating a pattern from the patterns as a marked pattern in accordance with an input from the user;
designating a hierarchical level of the hierarchical structure of the marked pattern as a reference level in accordance with another input from the user;
obtaining coordinates of the marked pattern using the position information of the patterns in the reference level; and
dumping the obtained coordinates to the display unit.

23. The computer program product according to claim 22, the instruction steps when executed by a computer performs steps including:
storing a plurality of hierarchical structures;
reading position information of all of the stored hierarchical structures;
sorting the position information to obtain a relationship between all of the stored hierarchical structures; and
displaying a tree indicating the relationship between all of the stored hierarchical structures.
